(19) United States
(12) Patent Application Publication
(10) Pub. No.: US 2005/0094697 A1
(43) Pub. Date: May 5, 2005

(54) Stripline laser

(75) Inventors: Karl-Heinz Armier, Hamburg (DE); Hermann Hage, Hamburg (DE)

Correspondence Address: LERNER AND GREENBERG, PA, P O BOX 2480, HOLLYWOOD, FL, 33022-2480, US

(73) Assignee: Rofin Sinar Laser GmbH

(21) Appl. No.: 11/011,402

(22) Filed: Dec. 14, 2004

Related U.S. Application Data
(63) Continuation of application No. PCT/EP04/00548, filed on Jan. 23, 2004.

(30) Foreign Application Priority Data
Jan. 30, 2003 (DE) 103 03 620.2

(51) Int. Cl. H01S 3/22

(52) U.S. Cl. 372/55

(57) ABSTRACT

A ribbon laser has a laser gas present between elongated electrodes, whose flat surfaces lie in pairs opposite one another. The laser contains a large number of electrode pairs and a respective narrow discharge chamber is formed between each of the pairs. The discharge chambers are optically intercoupled by folding reflectors and are positioned adjacent to one another in such a way that the central planes of the discharge chambers, running parallel to the flat surfaces of the electrodes, lie on a common plane. At least one waveguide is provided to guide the laser beam between the respective adjacent discharge chambers that are directly intercoupled.

### CROSS-REFERENCE TO RELATED APPLICATION

This is a continuing application, under 35 U.S.C. § 120, of copending international application No. PCT/EP2004/000548, filed Jan. 23, 2004, which designated the United States; this application also claims the priority, under 35 U.S.C. § 119, of German patent application No. 103 03 620.2, filed Jan. 30, 2003; the prior applications are herewith incorporated by reference in their entirety.

### BACKGROUND OF THE INVENTION

### FIELD OF THE INVENTION

The invention relates to a slab or stripline laser such as is known, for example, from Published, European Patent Applications EP 0 275 023, corresponding to U.S. Pat. No. 4,719,639, and EP 0 305 893, corresponding to U.S. Pat. No. 4,939,738.

In the case of these lasers, a laser gas is located between two-dimensionally extended electrodes situated opposite one another with their flat sides. Formed between the electrodes is a narrow discharge chamber in which the laser gas, in particular CO₂, is excited by a high-frequency voltage applied to the electrodes. In order to achieve laser action, resonator mirrors are disposed opposite the end faces of the narrow discharge chamber formed by the electrodes.

In the known stripline lasers, the heat input occurring during the gas discharge is dissipated by thermal conduction via the electrodes, generally formed of copper, such that a complicated gas circulation system is no longer required. Cooling laser gas by heat transfer to the electrodes cooled with water is sufficient with such stripline lasers, since the electrodes are relatively large in area and their mutual spacing, which is typically a few millimeters, is relatively small and so the volume of gas trapped between the electrodes is likewise relatively small in relation to the cooling area.

The laser output power attainable with slab or stripline lasers is a function of the area of the electrodes, it being possible to produce approximately 1.5 watts to 2.0 watts per cm² electrode area. In order to be able to attain high output powers, there is a need for large-area electrodes which, however, because of their non-uniform heating, can no longer be held sufficiently parallel to one another. Since the inner flat sides, that is to say those directed to the gas or discharge chamber, are heated, and the outer flat sides are cooled, a high temperature gradient required for thermal dissipation is produced such that the mutually opposite flat sides of an electrode differ in their thermal expansion. This gives rise to bending moments, the effect of which is that the electrodes have a greater spacing from one another at their ends than in the middle. The distortion thereby produced in the electrodes worsens the laser performance, that is to say its mode stability and mode purity. Since the sag increases with increasing length of the electrodes, only laser output powers of a few hundred watts can be achieved with the known lasers.

In order to attain laser output powers of the order of magnitude of a few kilowatts, it has therefore been proposed in International Patent Disclosure WO 94/15384 (corresponding to U.S. Pat. No. 5,600,668) respectively to subdivide large-area electrodes into a number of sections that are spatially separated from one another at least over a part of their thickness, and are supported such that the movements, caused by thermal expansion, of their flat sides directed away from the discharge chamber are opposed only by negligible mechanical resistance. In this way, the curvature of the entire electrode is split into individual curvatures of the sections that, in turn, are so small per se that they no longer influence the operating behavior of the laser, or influence it only insubstantially. This permits the use of electrodes that are up to 1 m long and 0.5 m wide.

In order to extract an even higher power, it would now be possible in principle to increase the dimensions of the electrodes as appropriate. However, such scaling is possible only conditionally. First, the production of very large electrodes with the accuracy required with regard to their planarity encounters limits in terms of production engineering. Second, for practical reasons it is reasonable to scale only in the longitudinal direction, since the required outlay on production for the resonator mirrors increases enormously with increasing transverse extent. However, scaling in the longitudinal direction leads, moreover, to a laser configuration with a longitudinal extent that is unsuitable in practice.

In order to increase the output power of a gas laser, it is known, for example from East German Patent 128 966, to make use of conventional gas lasers in which the laser gas is disposed in a discharge tube of a so-called folded resonator for which purpose there are two or more gas discharge tubes disposed next to one another and coupled to one another by folding mirrors.

Such a folded resonator configuration is also known for stripline lasers. Published, European Patent Application EP 0 305 893 A (corresponding to U.S. Pat. No. 4,939,738) or German Patent DE 196 45 093 C2 (corresponding to U.S. Pat. No. 5,936,993) disclose folding configurations in which two or more discharge chambers are coupled to one another via folding mirrors and are disposed to be either parallel or at an acute angle to one another in such a way that the folding plane is oriented either perpendicular or at an acute angle to the flat sides of the discharge chamber. However, it has emerged in practice that it is possible using such folding to attain at most a slight increase in power which is in no way proportional to the discharge volume, it having been possible to observe even a worsening in power with such known foldings in unfavorable cases.

### SUMMARY OF THE INVENTION

It is accordingly an object of the invention to provide a stripline laser that overcomes the above-mentioned disadvantages of the prior art devices of this general type, which is compact and it is possible to attain a higher output power with an acceptable design outlay.

In the case of the stripline laser, a laser gas is located between two-dimensionally extended electrodes respectively situated opposite one another in pairs with their flat sides, a plurality of electrode pairs being provided between which a narrow discharge chamber is formed in each case. The discharge chambers are optically coupled to one another with the aid of folding mirrors and disposed next to one another in such a way that the central planes, extending parallel to the flat sides of the electrodes, of the discharge chambers lie in a common plane. At least one waveguide is provided for guiding the laser beam between the adjacent discharge chambers respectively coupled to one another directly.

Since a stripline laser in accordance with these features is constructed from a plurality of relatively short electrode pairs that are disposed next to one another within a resonator and optically coupled to one another, the extractable laser output power can be multiplied in accordance with the number of electrode pairs used in conjunction with the same outlay in terms of production engineering and design. Since, the electrode pairs are disposed next to one another in such a way that the discharge path is folded in a central plane, running parallel to the electrodes, of the discharge chamber, and a waveguide is provided between the folding mirrors for guiding the light beam, the in-coupling and out-coupling losses can be distinctly reduced. This reduction is possible since the paths to be bridged on which the laser beam propagates freely can be of a very short design unlike in the case of the folding configurations known from the above-cited Published, European Patent Application EP 0 305 893 A2 (corresponding to U.S. Pat. No. 4,939,738) and German Patent DE 196 45 093 C2 (corresponding to U.S. Pat. No. 5,936,993), so as largely to avoid absorption of the laser beam by non-cooled, non-excited laser gas.

In a particularly advantageous refinement of the invention, the waveguide is formed by mutually spaced-apart metal plates which are connected to a high-frequency voltage. Owing to this measure, the space in which the laser beam propagates between the folding mirrors is used as a laser-active discharge chamber, and contributes to a further rise in power.

In a further advantageous embodiment, the waveguide is part of an electrode pair.

Other features which are considered as characteristic for the invention are set forth in the appended claims.

Although the invention is illustrated and described herein as embodied in a stripline laser, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, plan view of a stripline laser in accordance with the invention of a flat side of electrodes;

FIG. 2 is a diagrammatic, cross-sectional view of a folding mirror taken along the line II-II shown in FIG. 1; and

FIGS. 3-5 are illustrations of further exemplary embodiments for the stripline laser in accordance with the invention.

### DESCRIPTION OF THE PREFERRED EMBODIMENTS

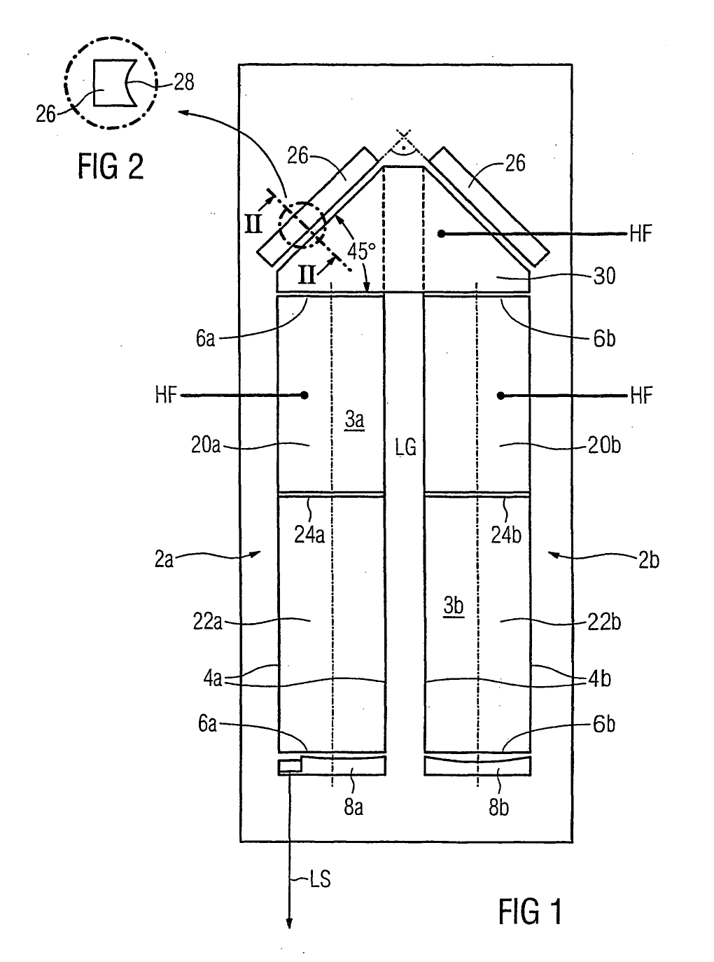

Referring now to the figures of the drawing in detail and first, particularly, to FIG. 1 thereof, there is shown a stripline laser formed of two electrode pairs 2a, 2b respectively containing two electrodes that are spaced apart from one another and extend in two dimensions, and of which only in each case the upper electrode is visible in the plan view in accordance with FIG. 1. Each of the electrode pairs 2a, 2b defines a narrow, cuboidal discharge chamber 3a, 3b with long sides 4a, 4b and end faces 6a, 6b, in which a laser gas LG is located. The discharge chambers 3a, 3b are disposed with their long sides 4a and 4b parallel to one another in such a way that the flat sides of their electrodes or the central plane of the discharge chambers 3a, 3b lie in a common plane parallel to the plane of the drawing.

A curved resonator mirror 8a, 8b is disposed in each case opposite one of the end faces 6a of the electrode pair 2a, and opposite the end face 6b, adjacent thereto, of the electrode pair 2b. The resonator mirror 8a serves as an out-coupling mirror, and the resonator mirror 8b serves as a reversing mirror. In the exemplary embodiment, the resonator mirrors 8a, 8b in the plane of the drawing form an unstable resonator of the negative branch, and a laser beam LS emerges from the resonator to the side of the resonator mirror 8a. The concave curvature required for this purpose by the resonator mirrors 8a, 8b is illustrated schematically in FIG. 1.

It is to be seen in FIG. 1 that the electrodes of the electrode pairs 2a, 2b in the exemplary embodiment each have two sections 20a, 22a and 20b, 22b, which are separated from one another by grooves 24a, 24b in accordance with the way explained in International Patent Disclosure WO 94/15384 (corresponding to U.S. Pat. No. 5,600,668) cited at the beginning. As an alternative thereto the sections 20a and 22a or 20b and 22b, respectively, can be completely separated from one another by a gap.

A plane folding mirror 26 is disposed opposite the respective end faces 6a and 6b, averted from the resonator mirrors 8a, 8b, of electrode pairs 2aand 2b, in each case at an angle of 45° to the end face 6a or 6b. The laser beams respectively emerging from a discharge chamber 3a or 3b at the end faces 6a or 6b are coupled into the adjacent discharge chamber 3b or 3a, respectively, with the aid of these folding mirrors 26.

In the exemplary embodiment, there is disposed between the folding mirrors 26 outside the discharge chambers 3a and 3b respectively formed by the electrode pairs 2a, 2b an approximately trapezoidal flat hollow waveguide 30 in which the laser beams emerging from the discharge chamber 3a or 3b at the end faces 6a, 6b propagate parallel to the folding plane. The waveguide 30 is formed by flat metal plates which are spaced apart from one another and, in an advantageous refinement of the invention, are connected just like the electrode pairs 2a, 2b to a high-frequency voltage HF such that the laser gas LG located between them can be used as a laser-active medium and can contribute to the laser power. Just like the electrode pairs 2a, 2b, the metal plates of the waveguide 30 are also cooled whenever they are not connected to a high-frequency voltage HF. The distance between the waveguide 30 and the electrode pairs 2a, 2b as well as between the waveguide 30 and the folding mirrors 26 should be as small as possible and not exceed a few mm. Values in the range of 3-4 mm have proved to be suitable in practice.

It is also possible in principle for the electrode pairs 2a, 2b to be advanced up to the folding mirrors 26 so that the waveguide 30 is formed by mutually adjacent triangular sections of the electrode pairs 2a, 2b, as is illustrated in FIG. 1 by dashes. It is then necessary in this exemplary embodiment for the electrode pairs 2a, 2b to be disposed with their long sides 4a, 4b close to one another, in order to minimize in-coupling losses.

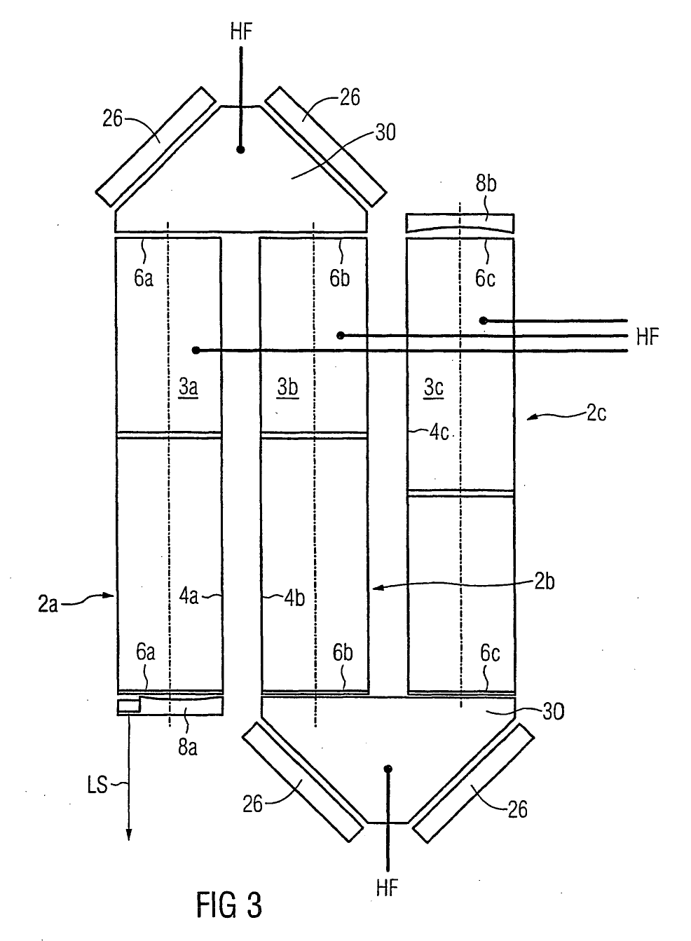

In accordance with FIG. 2, instead of plane folding mirrors 26 it is also possible to use folding mirrors 26 whose surface 28 has a curved contour in a planar section perpendicular to the plane of the drawing, in order to focus the laser beams into the adjacent discharge chamber.

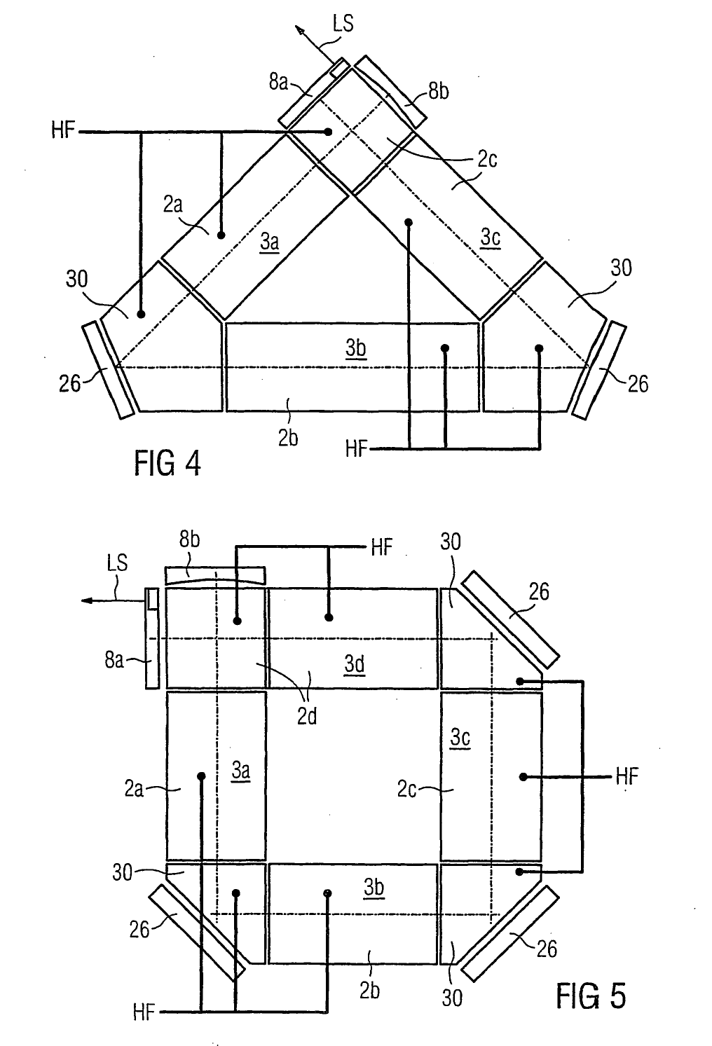

A configuration of two electrode pairs 2a, 2b is illustrated in FIG. 1. However, in principle it is also possible to dispose more than two electrode pairs next to one another, as is illustrated in the exemplary embodiment in accordance with FIG. 3 with the aid of a configuration having three electrode pairs 2a-2c and discharge chambers 3a-3c respectively assigned to these. In this configuration, as well, the discharge chambers 3a-c are disposed with their long sides 4a-4c parallel next to one another. Respectively adjacent electrode pairs 2a, 2b and 2b, 2c, respectively, are optically coupled to one another in this case by folding mirrors 26 assigned to these in pairs, the resonator mirrors 8a and 8c being disposed only at the end faces 6a and 6c of the external electrode pairs 3a and 3c.

Illustrated in the exemplary embodiment in accordance with FIG. 4 is a folding in which the electrode pairs 2a-2c and the waveguides 30 build up a triangular discharge path. In this case, as well, the waveguides 30 disposed in the case of the folding mirrors 26 are formed by electrodes and are supplied with the same high-frequency voltage HF as the electrode pairs 2a-2c such that the laser-active volume, that is to say the space in which a gas discharge takes place, reaches beyond the discharge chamber 3a-3c formed in each case by the electrode pairs 2a-2c as far as into the immediate vicinity of the folding mirrors 26, and passive paths are largely avoided in the case of the propagation of the laser beam LS in the interior of the resonator. A further exemplary embodiment is illustrated in FIG. 5 where the discharge chambers 3a-3d formed by the electrode pairs 2a-2d are coupled together with the waveguides 30 to form a square or rectangular discharge path.

In the exemplary embodiments in accordance with FIGS. 2 to 5, as well, the waveguides 30 can be an integral component of the electrode pairs and can, for their part, be split again into smaller sections by grooves, as is illustrated for the electrode pairs 2c (FIG. 4) and 2d (FIG. 5).

1. A stripline laser, comprising:
a laser gas;
two-dimensionally extended electrodes having flat sides and said flat sides disposed opposite one another in pairs, said laser gas disposed between said electrodes, said electrodes having a plurality of electrode pairs defining discharge chambers having central planes and each of said electrode pairs defining one of said discharge chambers, said discharge chambers disposed next to one another such that said central planes, extending parallel to said flat sides of said electrodes, lie in a common plane;
folding mirrors optically coupling said discharge chambers; and
at least one waveguide for guiding a laser beam between adjacent ones of said discharge chambers being respectively directly coupled to one another.

2. The stripline laser according to claim 1, wherein said waveguide is formed by mutually spaced-apart metal plates connected for receiving a high-frequency voltage.

3. The stripline laser according to claim 2, wherein said waveguide is part of one of said electrode pairs.

4. The stripline laser according to claim 1, further comprising resonator mirrors forming an unstable resonator of a negative branch in a plane parallel to said flat sides of said electrodes.

5. The stripline laser according to claim 1, wherein said folding mirrors are planar.

6. The stripline laser according to claim 1, wherein said folding mirrors are curved in a plane perpendicular to said flat sides of said electrodes.
